(19) United States
(12) Patent Application Publication
(10) Pub. No.: US 2025/0178473 A1
(43) Pub. Date: Jun. 5, 2025

(54) FACILITATING CHARGE SCHEDULING AND CHARGE OPTIMIZATION THROUGH A LINKAGE MECHANISM DISTINCT FROM A MOBILE APP

(71) Applicant: PowerFlex Systems, LLC, San Diego, CA (US)

(72) Inventors: Craig SMITH, Fenton, MO (US); Mathew WOODS, Shiloh, IL (US)

(21) Appl. No.: 18/963,012

(22) Filed: Nov. 27, 2024

Related U.S. Application Data
(60) Provisional application No. 63/605,205, filed on Dec. 1, 2023.

(51) Int. Cl. B60L 53/68; B60L 53/62; B60L 53/65; B60L 53/66; G06Q 50/06

(52) U.S. Cl. CPC B60L 53/68; B60L 53/62; B60L 53/65; B60L 53/66; G06Q 50/06

(57) ABSTRACT

Certain aspects of the present disclosure provide systems and methods for linking an electric vehicle to a charging session to facilitate charge scheduling and charge optimization. In examples, a method includes receiving a charging request initiated by a proximity-based communication from a wireless identification tag, the charging request including a wireless identifier associated with the electric vehicle and derived from the wireless identification tag. The method also includes authorizing the charging request based on the wireless identifier, retrieving a unique telematics identifier corresponding to the wireless identifier, and querying a telematics system with the unique telematics identifier to obtain vehicle-specific data, where the vehicle-specific data includes a state of charge attribute for a battery associated with the electric vehicle. The method further includes determining a charge amount based on the state of charge attribute and authorizing the determined charge amount for the charging session.

### CROSS-REFERENCE TO RELATED APPLICATIONS

This Application claims the benefit of and priority to U.S. Provisional Patent Application No. 63/605,205, filed on Dec. 1, 2023, the entire contents of which are hereby incorporated by reference.

### INTRODUCTION

Aspects of the present disclosure relate to management of electric vehicle fleets and management of charging infrastructure to support the electrical vehicle fleets.

Electric vehicles, including plug-in hybrid and fully electric vehicles, are increasing in popularity around the world. It is expected that the proportion of new electric vehicles sold each year out of the total number of vehicles sold will continue to rise for the foreseeable future. Moreover, while electric vehicle operators are primarily non-commercial at present (e.g., personal vehicles), commercial vehicle operators are increasingly adding electric vehicles to their fleets for all sorts of commercial operations, thus adding to the number of electric vehicles in operation throughout the world.

Management of fleets of electric vehicles and the charging infrastructure to support the fleets is challenging because of, in part, varying capabilities in electric vehicles within the fleets (e.g., battery capacity, battery recharge capability, range, on-board charging equipment compatibilities, etc.) and varying capabilities and availability of charging stations, such as electric vehicle supply equipment (EVSE). For example, different EVSE may have different charge levels (e.g., how much electric power can be delivered to the electric vehicle) and different plug-in interfaces. One challenge for fleet owners is assigning electric vehicles to tasks that require, for example, each electric vehicle to be able to travel a certain mileage. Additionally, because of internal constraints (e.g., matching electric vehicles with appropriate EVSE, etc.) and external constraints (e.g., cost and availability of power over charging period, etc.), it can be difficult for a fleet operator to understand the current status of the fleet and the effects that changes to the internal and external constraints will have on that status. While these challenges exist for both vehicle fleets of internal combustion engine (ICE)-powered vehicles as well as fleets of electric vehicles, the unique technological challenges inherent to electric vehicle fleets increase the difficulty of managing a fleet.

Fleet operators and managers play a critical role in overseeing the transition to electric mobility while ensuring the seamless operation of their fleets. Tracking the electric vehicle charging process within a fleet context is helpful for optimizing fleet management and decision-making. However, this practice has its challenges and complexities. For example, fleets often include diverse electric vehicle models with varying charging requirements and compatibility with different charging infrastructures. Tracking charging sessions for a heterogeneous fleet can be complex and may require tailored solutions for different electric vehicle types. In addition, efficiently managing charging schedules and coordinating charging activities across a fleet is challenging. Suboptimal charging planning can lead to electric vehicle downtime, reduced operational efficiency, and increased costs. Further, fleet operators need comprehensive charging data to make informed decisions about charging infrastructure expansion, optimal electric vehicle allocation, and energy consumption. Aggregating and interpreting data from various charging stations can be time-consuming and error-prone. Moreover, accurately attributing charging costs to individual electric vehicles or departments within a fleet is crucial for budgeting and cost analysis. Existing methods may lack precision, leading to inaccurate cost allocation. Integrating charging data with existing fleet management systems is helpful for holistic fleet oversight. However, achieving seamless integration across diverse platforms and data formats can be technically challenging. As fleets expand, manually tracking charging sessions becomes increasingly impractical and in some instances, virtually impossible.

Thus, fleet operators and managers require solutions that can scale efficiently as the fleet grows. One solution involves utilizing a mobile application as a means to link an electric vehicle to a charging session for secure charge scheduling and optimization purposes. Mobile applications, or apps, have emerged as versatile tools for providing a convenient interface for users to interact with a myriad of functionalities. However, the dependence on smartphone apps to obtain electric vehicle charging services is not without its own challenges and complications. For example, requiring users to use smartphone apps for obtaining electric vehicle charging services creates a strong dependency on mobile devices. This dependency excludes individuals who do not own smartphones or have limited access to mobile technology, thereby alienating a portion of potential users. Further, users must install and regularly update the corresponding apps on their smartphones. This process demands storage space and data consumption, and potentially incurs compatibility issues with different device models or operating systems. Moreover, certain circumstances may hinder access to the smartphone app, such as low battery, network connectivity issues, or phone malfunction. Thus, in some circumstances, users may be unwilling or unable to use the apps and relying solely on the app can make it difficult to obtain electric vehicle charging services when the app, or smartphone, is unavailable.

As such, there is a need to overcome these challenges to manage electric vehicle fleets and charging infrastructure to support the electrical vehicle fleets so that adoption and use of environmentally beneficial electric vehicles can be accelerated.

### SUMMARY

Certain embodiments provide techniques for linking an electric vehicle to a charging session to facilitate charge scheduling and charge optimization. In examples, a method includes receiving a charging request initiated by a proximity-based communication from a wireless identification tag, the charging request including a wireless identifier associated with the electric vehicle and derived from the wireless identification tag. The method also includes authorizing the charging request based on the wireless identifier, retrieving a unique telematics identifier corresponding to the wireless identifier, and querying a telematics system with the unique telematics identifier to obtain vehicle-specific data, the vehicle-specific data including a state of charge attribute for a battery associated with the electric vehicle. The method further includes determining a charge amount based on the state of charge attribute and authorizing the determined charge amount for the charging session.

Certain embodiments provide a system for linking an electric vehicle to a charging session to facilitate charge scheduling and charge optimization. The system includes a cloud environment that includes a memory component and a processor, the cloud environment including an app-less session service, that when executed by the processor, causes the system to: receive a charging request initiated by a proximity-based communication from a wireless identification tag, the charging request including a wireless identifier associated with an electric vehicle and derived from the wireless identification tag; authorize the charging request based on the wireless identifier; retrieve a unique telematics identifier corresponding to the wireless identifier; query a telematics system with the unique telematics identifier to obtain vehicle-specific data, the vehicle-specific data including a state of charge attribute for a battery associated with the electric vehicle; determine a charge amount based on the state of charge attribute; and authorize the determined charge amount for a charging session.

Certain embodiments provide a non-transitory computer-readable medium comprising computer-executable instructions that, when executed by a processor of a processing system, cause the processing system to: receive a charging request initiated by a proximity-based communication from a wireless identification tag, the charging request including a wireless identifier associated with an electric vehicle and derived from the wireless identification tag; authorize the charging request based on the wireless identifier; retrieve a unique telematics identifier corresponding to the wireless identifier; query a telematics system with the unique telematics identifier to obtain vehicle-specific data, the vehicle-specific data including a state of charge attribute for a battery associated with the electric vehicle; determine a charge amount based on the state of charge attribute; and authorize the determined charge amount for a charging session.

### DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a computing environment for linking an electric vehicle to a charging session to facilitate charge scheduling and charge optimization through a linkage mechanism distinct from a mobile app, according to embodiments provided herein;

FIG. 2 depicts a software configuration for edge environment, according to embodiments provided herein;

FIGS. 3A-3C depict device configurations for edge environment, according to embodiments provided herein;

FIGS. 4A-4C depict hardware that may be utilized for the devices from FIGS. 3A-3C, according to embodiments provided herein;

FIG. 5 depicts a cloud environment for linking an electric vehicle to a charging session to facilitate charge scheduling and charge optimization through a linkage mechanism distinct from a mobile app, according to embodiments provided herein;

FIG. 6 depicts example data structures, according to embodiments provided herein;

FIG. 7 depicts a flow chart for linking an electric vehicle to a charging session to facilitate charge scheduling and charge optimization through a linkage mechanism distinct from a mobile app, according to embodiments provided herein;

FIG. 8 depicts a flow chart for linking an app-less charging session to another charging session, according to embodiments provided herein; and

FIG. 9 depicts an example processing system configured to perform the methods described herein.

### DETAILED DESCRIPTION

Managing electric vehicle fleets and their charging infrastructure presents several technical challenges. Various electric vehicles in a fleet may have different battery capacities, charging capabilities, and compatibility with different charging stations. This makes it difficult to efficiently schedule and optimize charging across a diverse fleet. In addition, tracking individual electric vehicle charging sessions and attributing charging costs can be complex and error-prone with existing systems. As fleets expand, the ability to manually track charging sessions for all electric vehicles becomes infeasible. Furthermore, existing systems that rely solely on smartphone apps for managing electric vehicle charging exclude users without smartphone access. Requiring an app for charging services creates dependency issues if a user's phone is unavailable due to low battery, connectivity problems, or other issues. This can prevent the user from obtaining charging services when needed.

Embodiments disclosed herein overcome these technical challenges by utilizing radio frequency identification (RFID) identifiers associated with electric vehicles to initiate and track charging sessions, independently of a smartphone app. The RFID identifier allows retrieval of specific electric vehicle telematics data including real-time battery state of charge. This enables tailored charge requests optimized for an individual electric vehicle battery's needs. Costs and electric vehicle charging data can be accurately tracked based on the RFID identifier. Embodiments disclosed herein provide a scalable solution as fleets expand and remove reliance on smartphone apps to obtain charging services. This improves management of diverse electric vehicle fleets and charging infrastructure without excluding users.

Embodiments disclosed herein include systems and methods for linking an electric vehicle to a charging session to facilitate charge scheduling and charge optimization through a linkage mechanism. In some embodiments, this can occur within or otherwise operate in conjunction with a mobile app environment. Embodiments provided herein can utilize a peer-to-peer communication protocol or personal area network (PAN), such as RFID card assigned to an electric vehicle to initiate a data flow that gathers information used to build an energy request to optimize power consumption across a network of charging stations, generally reducing user interaction to a mere initial presentation of the RFID card to an RFID card reader of an EVSE. Embodiments described herein not only use RFID as a security and authorization method but also provide that a generation of an energy request for purposes of charging an electric vehicle is mostly hands free (e.g., the energy request can be generated upon the initial presentation of the RFID card to the RFID reader) by leveraging many components of the existing app environment and backend.

In embodiments, an identifier associated with an RFID card can be assigned to a specific electric vehicle. Upon receiving the RFID identifier and a charging network identifier, a comparison can be made to determine if the RFID identifier is authorized for charging services provided by the charging network. In some embodiments, the RFID identifier can be assigned to or otherwise associated with a unique electric vehicle identifier, such as a vehicle identification number (VIN) of the electric vehicle. Accordingly, if the RFID identifier matches a VIN that is authorized for charging services, telematics information associated with the VIN can be determined and communicated to a device on the charging network. Such telematics information can include a state of charge of the electric vehicle, charge capacity of the electric vehicle, recommended charge rate, an electric vehicle schedule, etc. Accordingly, the charging network can then determine an amount of energy needed by the electric vehicle based on a schedule and the current state of charge of the electric vehicle battery. In some examples, and based on the amount of energy needed and electric vehicle schedule, an estimated relative time can be determined, where the relative time can refer to when a charge operation will complete or when the electric vehicle will be ready for service or subsequent operation.

In some embodiments, when the RFID identifier is received, an app-less session identifier is created. The app-less session identifier can be utilized to populate or otherwise claim a charging session that may be associated with or assigned to a particular fleet customer, driver, member, etc. Thus, charging session information associated with the app-less charging session can be retrieved via a portal or app. The systems and methods for linking an electric vehicle to a charging session incorporating the same will be described in more detail, below.

Overall, the techniques described herein provide a technical solution to challenges inherent in electric vehicle fleet and charging infrastructure management. The techniques improve monitoring, attribution, optimization, and access to charging services through a combination of app-less RFID-based session initiations integrated with existing mobile app infrastructure. This represents an advancement to the technical field.

### Example Computing Environment for Providing an Edge Hardware Platform

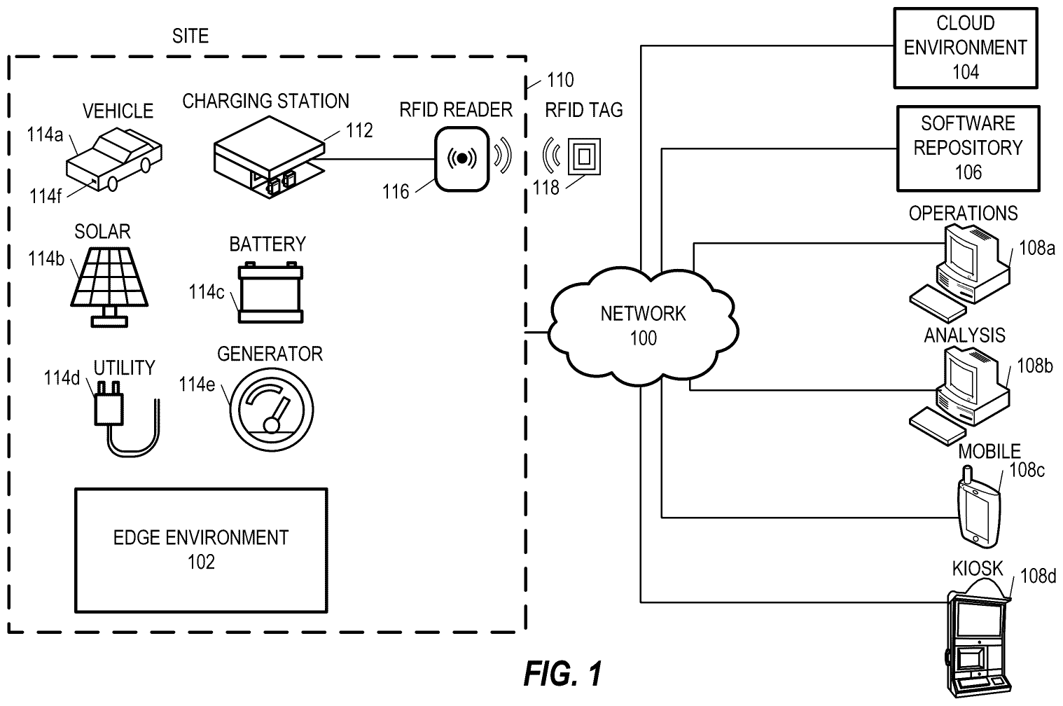

Referring now to the drawings, FIG. 1 depicts a computing environment for providing an edge hardware platform having the ability to link an electric vehicle to a charging session using a linkage mechanism distinct from a mobile app, according to embodiments provided herein. As illustrated, the computing environment includes a network 100 that is coupled to an edge environment 102, a cloud environment 104, a software repository 106, as well as ancillary devices 108. The network 100 may be configured as any wide area network (WAN, such as the internet, power network, cellular network, etc.) or other network for facilitating communication among the edge environment 102, the cloud environment 104, the software repository 106 and the ancillary devices 108.

Edge environment 102 may generally be deployed at site 110 to provide various services, including coordination and optimization of energy assets 114, such as charging of electric vehicles (e.g., electric vehicle 114a) using charging station 112 and various distributed energy resources (DERs), such as solar installation 114b, batter energy storage system (BESS) 114c, utility grid connection 114d, and generator 114e (e.g., an onsite diesel, natural gas, or other type of fueled generator). Generally, the aforementioned DERs may provide energy to the charging station 112 and/or use energy from the charging station 112 (e.g., by way of a backflow of energy from electric vehicle 114a to other aspects of site 110). In some embodiments, charging station 112 may send excess energy back to the BESS 114c and/or to utility grid connection 114d. Generally, edge environment 102 may monitor and/or modify the energy sent to and received from the DERs to optimize various tasks, such as charging of electric vehicle 114a.

Charging station 112 may utilize various communication protocols, such as open smart charging protocol (OSCP), open charge point interface (OCPI), ISO 15118, OpenADR, etc. and may represent Level 1, Level 2, Level 3, and higher level charging stations, as applicable. Generally, the “level” of a charging station refers to the power level and/or ability to provide electric power to a device being charged. In addition, the charging station 112 can be associated with an RFID reader 116, where the RFID reader 116 can receive or otherwise obtain a unique identifier associated with an RFID card 118. RFID technology involves the use of radio waves to automatically identify and track objects equipped with RFID tags, such as the RFID card 118. These tags can store and transmit data, enabling rapid and non-contact communication between devices, such as between the RFID card 118 and the RFID reader 116. For example, the RFID reader 116 can emit radio waves having a specific frequency. When the RFID card 118 comes into proximity of the reader, the RFID card 118 receives the emitted radio waves. The RFID card 118 then uses the energy from the received radio waves (in the case of a passive RFID tag or card) or an internal battery of the RFID card 118 (in the case of active or semi-passive tags or cards) to power a microchip and send a response back to the RFID reader 116, where the response can include stored data and/or a unique identifier. In examples, the communication between the RFID card 118 and the RFID reader 116 can be described as a short-range communication, a near-field communication, a limited distance communication, a proximity-based communication, a contactless short-range interaction, and/or a finite-range data exchange. Other methods of uniquely receiving an identifier associated with an electric vehicle are contemplated. For example, a QR code or image can be obtained, where the QR code or image uniquely identifies or otherwise refers to an electric vehicle. In examples, an identifier associated with the QR code or image can be matched to an identifier maintained in a fleet database, such as an electric vehicle VIN. Alternatively, or in addition, information associated with the electric vehicle can be obtained by directly interrogating one or more onboard systems of the electric vehicle. For example, a telematics module 114f can be interrogated to obtain information that can be matched to an identifier maintained in a fleet database.

Edge environment 102 is configured as an interface between various aspects of site 110 and network 100. In various embodiments, compute resources for performing different functions at a site, such as optimization of electric vehicle charging, may be split between local compute resources in edge environment 102 and remote compute resources, e.g., in cloud environment 104 of FIG. 1.

Cloud environment 104 is coupled to the edge environment 102 via the network 100 and may be configured for further processing of data, as described herein. While FIG. 1 depicts a single cloud environment 104 that serves a single edge environment 102, this is merely an example, as some embodiments may be configured such that the cloud environment 104 may serve a plurality of edge environments 102 that each serve one or more sites 110, one or more charging stations 112, one or more DERs, and the like.

Software repository 106 is also coupled to site 110 via network 100. Software repository 106 may be configured as a platform to program, store, manage, control changes, etc. to software that is implemented in edge environment 102 and/or cloud environment 104. In some embodiments, software repository 106 may be configured as a proprietary service and/or may be provided by a third-party, such as GitHub™. Additionally, some embodiments may be configured such that the software repository 106 is provided by the same entity that manages the cloud environment 104. As such, these embodiments may be configured such that software repository 106 and cloud environment 104 may be combined.

Also depicted in FIG. 1 are the ancillary devices 108. The ancillary devices 108 may include an operations device 108a, an analysis device 108b, a mobile device 108c, a kiosk 108d, and/or other devices. Specifically, the operations device 108a may be utilized to monitor and/or alter operations of the environment provided in FIG. 1. The analysis device 108b may analyze utilization, operation, charging, and/or other features of the computing environment. The mobile device 108c may represent an administrator device and/or a user device. As a user device, the mobile device 108c may initiate charging, payment, and/or perform other user-specific actions. As an administrator device, the mobile device 108c may perform administrative operations, analysis, and/or perform other actions. The kiosk 108d may be located at one of the charging stations 112 and/or remote therefrom and may provide user-specific or administrative actions, similar to that of the mobile device 108c. In some embodiments, administrators may use the kiosk 108d to view information about the site or make changes. As will be understood, the ancillary devices 108 may each include a processor, a memory component, and/or other hardware and/or software for performing the functionality provided herein. It should be understood that while the kiosk 108d is depicted as being remote from the site 110, some embodiments may not be configured in this manner. Specifically, some embodiments may utilize a local kiosk 108d, which may communicate via a local network and/or the network 100 for providing the services described herein.

### Example Aspects of an Edge Environment

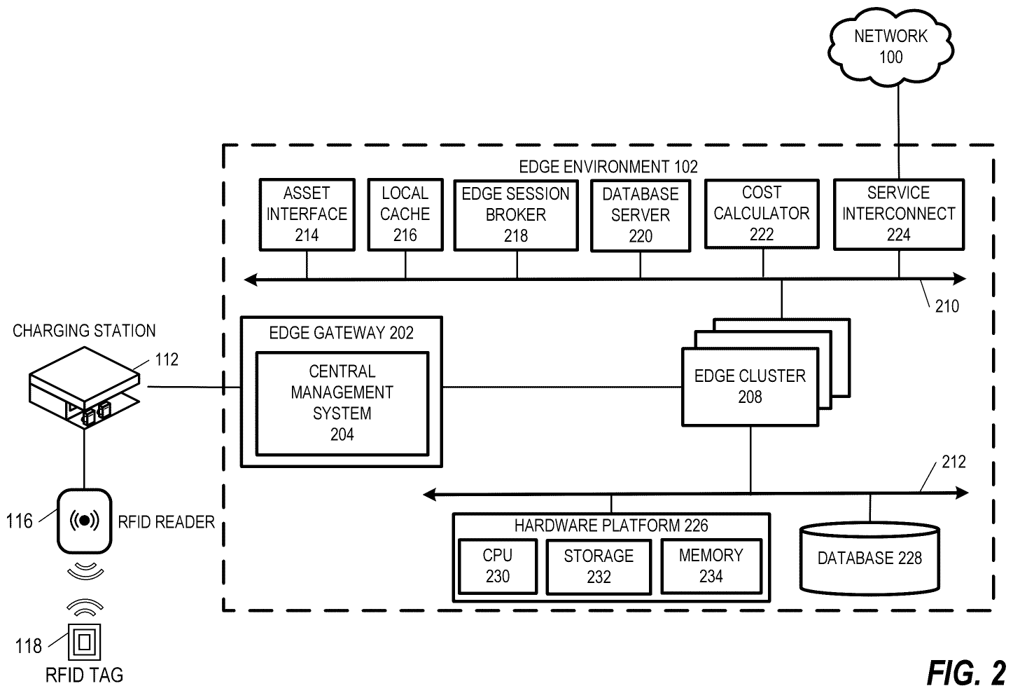

Referring to FIG. 2, the edge environment 102 may be coupled to the site 110 via an edge gateway 202. Edge environment 102 may be operatively coupled to aspects of site 110, such as charging station 112 via edge gateway 202. Edge environment 102 further includes a central management system 204 and an edge cluster 208, which is coupled to communication bus 210 and hardware bus 212. Communication bus 210 is coupled to asset interface 214, local cache 216, edge session broker 218, database server 220, cost calculator 222, and service interconnect 224 in this example. Hardware bus 212 is further coupled to hardware platform 226, which may include one or more processors, such as CPU 230, storage component 232, memory component 234, and/or other hardware components. Also coupled to hardware bus 212 is database 228.

Buses 210, 212 may be utilized to facilitate operation of all services that run in edge environment 102 and communicate with each other via a distributed message streaming system. The coupling of these aforementioned services may be accomplished in one embodiment via a distributed message streaming system, such as a message oriented middleware like NATS.

In the depicted example, charging station 112 is configured for communication with edge environment 102 via edge gateway 202 via a short-range wireless network technology, such as via a Zigbee® PAN. The edge gateway 202 may be configured to receive data, such as electric charging data, price charge data, electric vehicle data, etc. from the charging station 112 and/or electric vehicles that are being charged via the connection with the site 110 (of FIG. 1).

In some embodiments, edge gateway 202 may be configured to abstract data received from aspects of site 110 (of FIG. 1), such as charging station 112, to remove protocol-specific distinctions. For example, a first charging station may utilize a first communication protocol and/or billing protocol and a second charging station may utilize a second communication protocol and/or billing protocol. Edge gateway 202 may receive data packets from both the first charging station using the first communication protocol and the second charging station using the second communication protocol and may transform the received data into a protocol-agnostic format prior to providing the data to edge cluster 208. This allows wide interoperability between edge environment 102 and various types of hardware (e.g., charging station 112) at a site. In some examples, an RFID identifier associate with an RFID card 118 can be received at the RFID reader 116 and provided to the edge gateway 202. In some examples, an RFID identifier is derived from the RFID card 118. In some examples, the RFID identifier is unique data or information stored in the RFID tag of the RFID card 118. The edge gateway 202 can provide a communication containing an identifier associated with the RFID card 118 to central management system 204, where the central management system 204 can convert the communication to a format compatible with one or more communication protocols prior to providing the identifier associated with the RFID card 118 to edge cluster 208.

Edge cluster 208 is the central message center in various embodiments. For example, when a user plugs an electric vehicle into a charging station 112, edge cluster 208 receives data from edge gateway 202, parses that data (e.g., to generate access state data) and causes the state data to be sent to the database server 220. Edge cluster 208 also receives the data and creates a session entry, which may be stored in the local cache 216. Edge cluster 208 may additionally send the session entry to the cloud environment 104 (of FIG. 1) via network 100. Edge session broker 218 may also receive data related to the new session and may query database server 220 to access additional session data to determine charging characteristics for charging station 112.

The edge session broker 218 may produce data or signals that are sent to the edge cluster 208, which may be sent to the edge gateway 202 for potentially sending back to one or more of the charging stations 112. Information that may be reported might include current delivered over time (e.g., amperes), total energy delivered (e.g., kWh), power delivered over time (e.g., kW), voltage at the charging station over time (e.g., V), charging station state (e.g., connected, disconnected, offline), connectivity state, charging state, etc. The charging stations 112 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and the energy assets 114.

Edge cluster 208 may be configured such that any message received by the edge cluster 208 may also be sent to the cloud environment 104 (of FIG. 1) for consumption by a data subscriber in the cloud environment 104. For example, if a user of the mobile device 108c (in FIG. 1) desires to claim a charging session, mobile device 108c does not need to access edge environment 102 directly. Instead, mobile device 108c may connect with the cloud environment 104 (of FIG. 1), which sends a message to the edge cluster 208 with an instruction to claim the session. Service interconnect 224 is configured for establishing an HTTP, TCP, and/or other type of communication with the cloud environment 104 (of FIG. 1) via network 100.

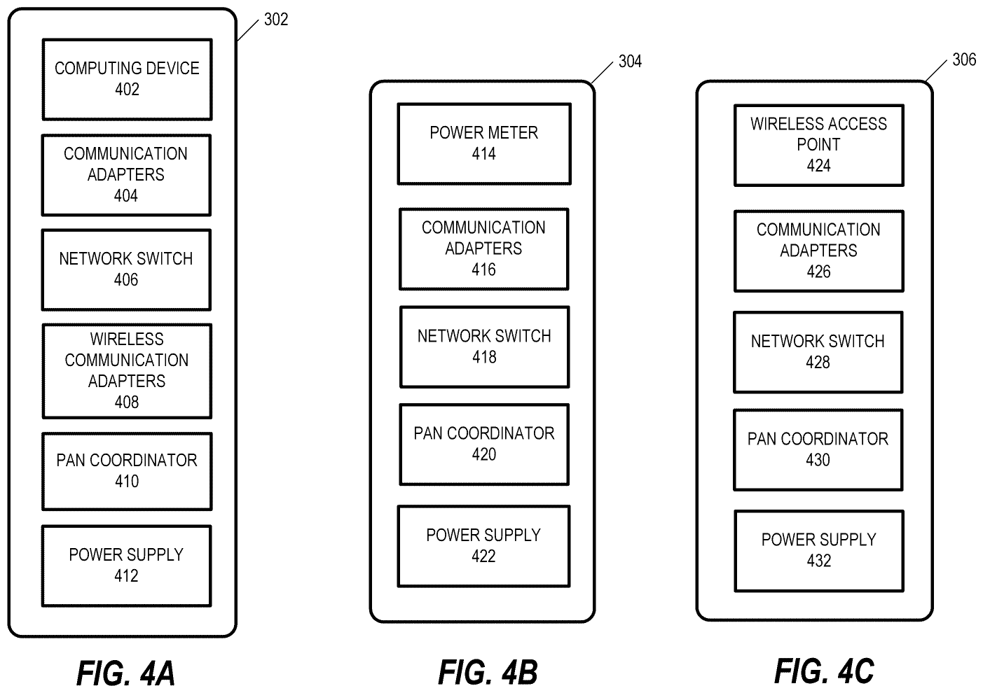

Hardware platform 226 represents any hardware for facilitating the processes and actions described herein. Specifically, CPU 230 may represent one or more types of processing devices configured for executing instructions. Storage component 232 may be configured as long term storage, such as a hard drive or the like. Memory component 234 may include any of various types or read access memory or the like. Database 228 may be configured for additional storage and may be housed with the other hardware and/or elsewhere. Examples of different hardware platforms that may be deployed in edge environment 102 are described further below with respect to FIGS. 4A-4C.

### Hardware Configurations for Edge Environment

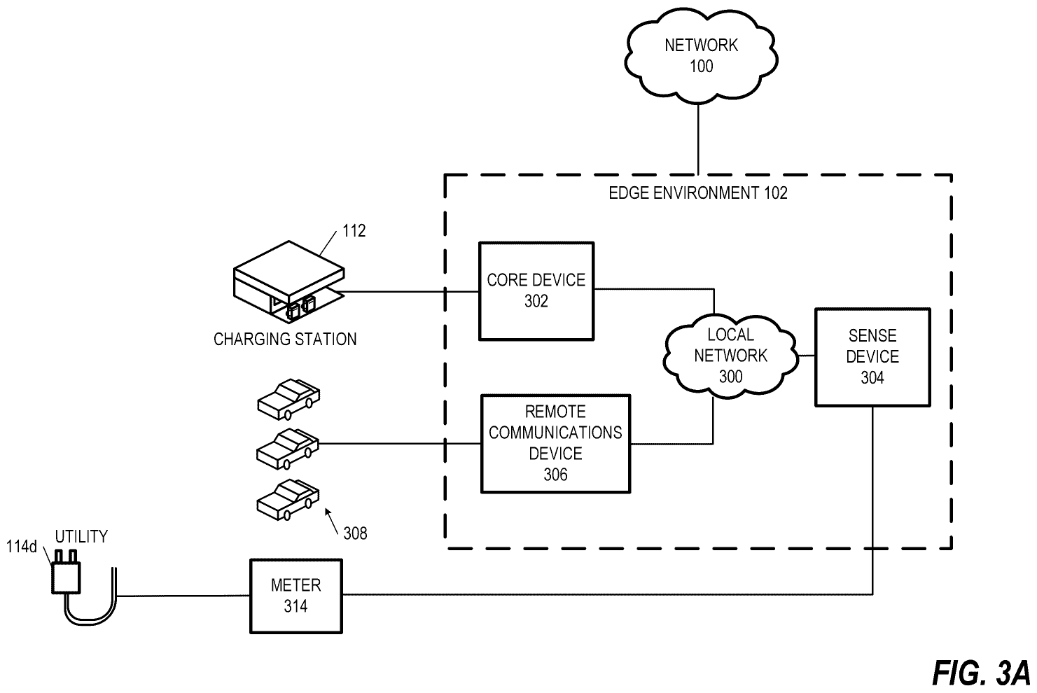

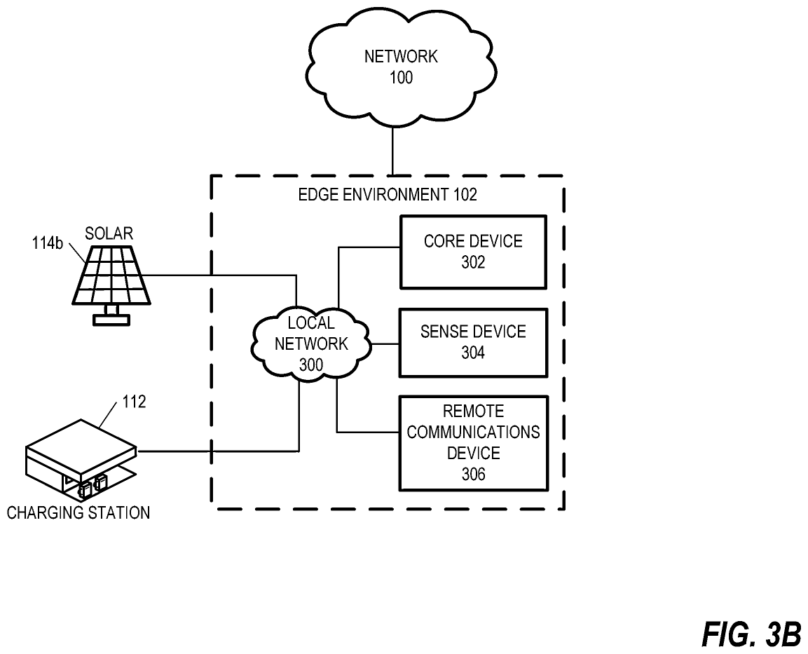

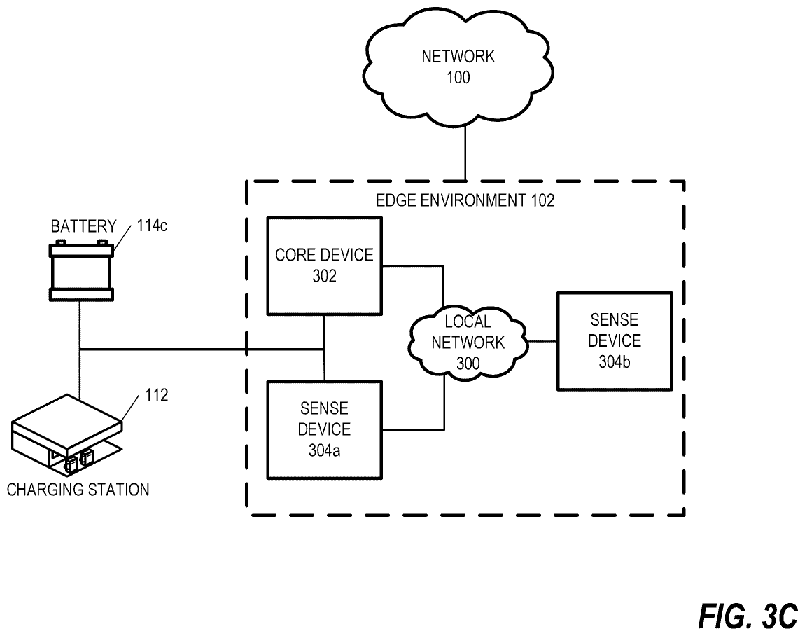

FIGS. 3A-3C depict example hardware configurations for the edge environment 102, according to embodiments provided herein. Specifically, FIG. 3A depicts a charging solution. As illustrated, the charging station 112 is coupled to a local network 300 via core device 302. The local network 300 may include any local area network, Ethernet, PAN, etc. The core device 302 may be physically installed within communications range of the chargers in the charging station 112. A sense device 304 may be installed, for example, in an electrical room or in another enclosure with electrical equipment of the charging station 112 and/or one or more energy assets 114 to monitor the main metering point for the local utility point of common coupling. This enables algorithms to provide the optimal dispatch of electric vehicle charging power, subject to local energy rates and the electric vehicles currently charging. In the case that there are electric vehicles 308 using electric vehicle chargers that are out of communications range of the core device 302, such as at a sub-level of a parking garage, a remote communications device 306 is included as required. Also included at the site 110 is a meter 314 for communicating energy with the utility grid connection 114d.

In the embodiment of FIG. 3A, the core device 302 is the central processing device and serves as the communications hub. The core device 302 may provide optimization, load management, communication coordination, and data historian services. The core device 302 communicates with the cloud environment 104 via cellular modem, wired internet service provider (ISP), and/or other communications medium to get current optimization and load management set points for charging stations 112 and other assets, such as via an optimization algorithm that may be stored locally and/or at the cloud environment 104. It will be understood however, that some embodiments may be configured such that the core device 302 performs optimization locally. Regardless, the core device 302 dispatches these set points, through a local communications protocol (e.g., Wi-Fi) and/or via the remote communications device 306 to reach locations that are distant or hard to reach, such as charging stations with a core device 302 and/or sense device 304 at sub-levels of a parking garage or a rooftop solar inverter. The core device 302 additionally collects data directly from distributed energy resources and power measurement devices or through cloud-based communications with the network 100.

Power and energy metering data may be collected via the sense device 304. The sense device 304 may include a smart meter with support for multiple single- and three-phase loads with a local historian and Ethernet communication back to the device via the local network 300. The sensing device may also incorporate support for additional devices running on the edge including but not limited to thermocouple wiring, weather stations, temperature sensors, pyranometers, etc. It should be noted that additional sense devices 304 and remote communications devices 306 can be added to handle a variety of situations, such as a separate subpanel for energy metering of a new solar or for monitoring of a new inverter associated with a rooftop solar installation.

FIG. 3B depicts a solar application where the core device 302 and the sense device 304 are installed in the facility's electrical room or other common area. The sense device 304 can monitor the main metering point for the local utility as well as the solar production at tie-in breakers for the solar installation 114b. The remote communications device 306 may be installed in a position to communicate directly with the solar installation 114b and report the data received from the solar installation 114b to the core device 302. Accordingly, the core device 302, the sense device 304, and the remote communications device 306 depicted in FIG. 3B may perform similar functions as those devices depicted in FIG. 3A.

FIG. 3C depicts a battery application where the core device 302 and the sense device 304 are physically installed near a BESS 114c storage installation. In cases where the BESS 114c is near the point of common coupling with the utility grid connection 114d, a single sense device 304a can monitor the full site. In cases where there is a significant distance to the metering point for the utility grid connection 114d, a second sense device 304b (or a plurality of sense devices 304b) may be installed near the utility meter, such as the electrical room.

### Hardware Components in Core, Sense, and Remote Communications Devices

FIGS. 4A-4C depict hardware that may be utilized for the devices from FIGS. 3A-3C, according to embodiments provided herein. Specifically, FIG. 4A depicts hardware components that may be present in a core device 302. In some embodiments, the core device 302 is the brain where the energy optimization and adaptive load management functions are executed and dispatched. As illustrated, the core device 302 may include a computing device 402, a communication adapter 404 (or more than one), a network switch 406, a wireless communication adapter 408 (or more than one), a PAN coordinator 410, and a power supply 412. As will be understood, the computing device may include a processor, memory, and/or other components that a normal, specific purpose machine may utilize. In some embodiments, the computing device 402 may include powerline communication (PLC) infrastructure, while some embodiments may utilize retail and/or micro-industrial computer components for optimization, load management, communication coordination, and/or historian services.

The communication adapter 404 may be configured for load balancing and otherwise managing communications, such as Modbus RTU (RS485) to Modbus TCP (Ethernet) or Ethernet IP (RJ45) to Ethernet Optical (SFP), etc. The network switch 406 may be configured for routing of network traffic, and may be configured as an Ethernet switch for communication to other nodes (e.g., the sense device 304, the remote communications device 306, and/or other core device 302), distributed energy resources, and/or energy based management systems.

The wireless communication adapter 408 may include a cellular modem, internet modem, Wi-Fi access point, etc. for facilitating wireless communications to the internet or other wide area network. Similarly, the PAN coordinator 410 may be configured to create and/or join communication connections with other devices. This may include a Zigbee coordinator, Bluetooth device, and/or other device for performing this function. The power supply 412 may be configured as a battery power, connection to external power, etc.

It should be understood that in some embodiments, the computing device 402 may be embodied as part of the edge environment 102 from FIG. 2. Specifically, the core device 302 may be configured as the central computing device of the edge environment and thus may provide the processing and workflow described with reference to FIG. 2. Some embodiments are not so limited.

FIG. 4B depicts hardware components of the sense device 304 from FIGS. 3A-3C. The sense device 304 may be configured as a smart-metering piece for collection and storage of power/energy data including but not limited to measurements such as temperature, voltage, current, power, solar irradiance, wind speed, etc. The sense device 304 may include a smart meter with multiple channels of measurement that may comprise single-phase circuits and/or three-phase circuits. The sense device 304 may communicate meter data back to the core device 302 from meter locations such as electrical rooms, rooftop solar installations, electric vehicle chargers, and subpanels. These embodiments may be optimized for ease of installation and reduced intrusion to the site. Power over Ethernet (POE) sourced from the core device 302 suffices for most installations. The sense device 304 may transmit data back to the core device 302 via a network switch. The sense device is optimized to utilize minimal power and PoE is acceptable for most installations.

As illustrated in FIG. 4B, the sense device 304 includes a power meter 414, a communication adapter 416 (or more than one), a network switch 418, a PAN coordinator 420, and a power supply 422. The power supply 422 may include a power interface for providing power to the sense device 304. The power meter 414 may be utilized for monitoring single-phase and three-phase loads of power. The communication adapter 416 may be utilized for facilitating communications between the sense device 304 and other devices. The network switch 418 may be a PoE enabled switch for communication. Similarly, the PAN coordinator 420 may create and/or join personal area networks, such as via Zigbee, Bluetooth, and the like. In some embodiments, PoE or other power source may be utilized.

As illustrated in FIG. 4C, the remote communications device 306 is a network-connectivity extension, primarily for electric vehicle charging or solar monitoring locations where Zigbee, Wi-Fi, or Ethernet is being extended to remote or difficult-to-reach locations such as remote subpanels, parking garage levels, or rooftop inverters. Some embodiments are optimized for ease of installation and reduced intrusion to the site where PoE suffices for most installations from the core device 302. The remote communications device 306 may be configured to transmit data back to the core device 302 via the network switch.

Specifically, the remote communications device 306 may include a wireless access point 424, a communication adapter 426 (or more than one), a network switch 428, a PAN coordinator 430, and a power supply 432. The wireless access point 424 may be configured to extend wireless communication signals to chargers and/or other intelligent electronic devices. The communication adapter 426 may be configured for facilitating communications between the remote communications device 306 and other devices. The network switch 428 may be configured as a PoE Ethernet switch and/or other network switch for communicating with the core device 302. The PAN coordinator 430 may be configured to create and/or join personal area networks, such as via Zigbee, Bluetooth, and the like. The power supply 432 may include a power interface for providing power to the remote communications device 306.

### Components of Cloud Environment

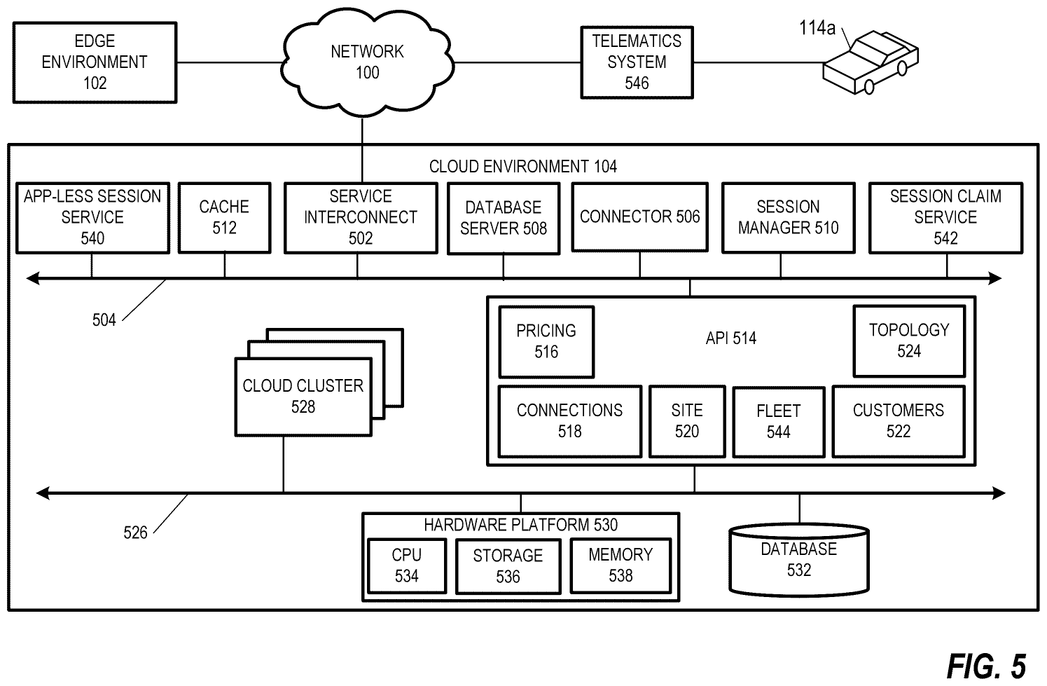

FIG. 5 depicts a cloud environment 104 for providing an edge hardware platform having the ability to link an electric vehicle to a charging session using a linkage mechanism distinct from a mobile app, according to embodiments provided herein. As illustrated, the network 100 may couple to the cloud environment 104 via a service interconnect 502 that corresponds with the service interconnect 224 from FIG. 2. Similar to the service interconnect 224 from FIG. 2, the service interconnect 502 may be configured to facilitate an HTTP, TCP, and/or other communication portal through the network 100 to the edge environment 102 for the exchange of data between the edge environment 102 and the cloud environment 104. The service interconnect 502 is also coupled to a communication bus 504, which facilitates communication among various components of FIG. 5. Also connected to the communication bus 504 are a connector 506, a database server 508, a session manager 510, a cache 512, an app-less session service 540, a session claim service 542, and a collection of services and application programming interfaces (APIs) 514. The API 514 may include a pricing API 516, a connections API 518, a site API 520, a customers API 522, a topology API 524, and a fleet API 544. The API 514 may be implemented by the hardware platform 530. The hardware bus 526 is coupled to a cloud cluster 528, as well as the hardware platform 530 and a database 532. The hardware platform 530 may include a CPU 534, a storage component 536, and a memory component 538.

The API 514 is a component of the cloud environment 104. As such, the API 514 and sub-components 516-524 and 544 may cause storage of and/or process site information, site topology, customers, connections to panels, constraints of panels, pricing information of each site, local forecasting services, optimization services, controller services, and caching services, etc. The API 514 may also serve as a mobile backend by storing personal information of charge users (e.g., email, charging preferences, payment preferences, privileges, access, fleet information, etc.). The API 514 may additionally store peak charging configurations, data related to meter setup, etc.

When an electric vehicle is plugged into a charging station 112 (of FIG. 1), the edge session broker 218 (of FIG. 2) communicates connection information to the API 514. The connection information may include electric vehicle information, user information, charge station information, etc. The API 514 then creates a charge session object, which is stored in the cache 512. The cache 512 sends the session data, along with topology constraints and the charge session object to the edge environment 102. The connector 506 may additionally cause the cloud cluster 528 to maintain the charge session object for retrieval by an interested party. As the session continues, the session manager 510 may be utilized to alter constraints of the session, which may cause the cloud cluster 528 to update the charge session object.

The telematics system 546 communicatively couples to telematics systems of electric vehicles 114a that are configured to use the charging stations 112. For example, the processing unit and/or infotainment unit of the electric vehicle 114a may operate an application that connects the telematics control unit of the electric vehicle 114a to the telematics system 546 through a wireless connection (e.g., a wireless local area network, a cellular data network, a wide area network, etc.). In some examples, the electric vehicle 114a may include a separate electronic control unit (sometimes referred to as a “telematics control unit”) to collect telematics data from the electric vehicle 114a and communicatively couple to the telematics system 546. The telematics system 546 collects telematics data from the electric vehicle 114a, where the telematics data includes, for example, data related to the state of the battery of the electric vehicle 114a (e.g., plugin state, charging rate, and/or state of charge, etc.) and data related to the operation of the electric vehicle 114a (e.g., location data, occupant data, diagnostic data, mileage, planned trips, etc.).

When the edge environment 102 receives RFID identifiers associated with an RFID card and a charging network, the RFID identifiers can be provided to the app-less session service 540. The app-less session service 540 can utilize the fleet API 544 to determine if there is an entry in a fleet database, such as database 532, associated with the received RFID identifier. In embodiments, if the fleet API 544 determines that the RFID identifier associated with the RFID card exists, a unique identifier associated with an electric vehicle can be obtained. In examples, the unique identifier can be the electric vehicle VIN. In some instances, other information associated with the electric vehicle 114a can also be obtained. For example, an electric vehicle object including, but not limited to, the VIN, electric vehicle schedule, battery capacity, etc., can be provided back to the app-less session service 540. In examples, the app-less session service 540 can contact the telematics system 546 to retrieve real-time information associated with the electric vehicle 114a. For example, the real-time information associated with the electric vehicle 114a can include, but is not limited to, a current state of charge associated with the battery of the electric vehicle 114a.

Utilizing the telematics information, the app-less session service 540 can calculate an amount of energy needed to charge the battery of the electric vehicle 114a based on the current state of charge of the battery and the schedule information associated with the electric vehicle 114a. The app-less session service 540 can convert or otherwise provide a relative time corresponding to when the calculated amount of energy will have been transferred to the battery of the electric vehicle 114a such that the electric vehicle 114a is ready in accordance with the electric vehicle 114a schedule. That is, the app-less session service 540 can provide a time associated with when the electric vehicle 114a will be capable of performing an assigned job at the requested time. For example, a job may be a delivery route or a car rental period, etc. where the electric vehicle 114a needs to have a minimum range (e.g., a minimum state of charge to support a range) by a deadline (e.g., the start of the rental period, the start of the delivery route) with a certain capacity (e.g., capacity for four passengers, cargo capacity of twenty cubic feet, etc.). Thus, in some embodiments, the charge request determined by the app-less session service 540 can be for less than an amount of charge needed to bring the battery to a fully charged status.

When a user claims a previously created session with the mobile device 108c, the database server 508 may create a database entry with the charge session, driver, along with energy request, willingness to pay, electricity purchased, etc. The connector 506 may update the cloud cluster 528 with the database entry. This data may then be sent to the edge environment 102. When the charge session ends (e.g., the electric vehicle is unplugged), that action will be added to the database entry and the database entry may be moved from a current sessions list to a completed sessions list.

When a user claims a previously created app-less session, the database server 508 may create a database entry with information specific to the app-less session, where the app-less session may reference that a charging session was initiated or occurred based on the receipt of an identifier associated with an RFID card. In some examples, the database entry can include the charge session, driver, RFID identifier associated with the RFID, energy request, willingness to pay, electricity purchased, etc. The connector 506 may update the cloud cluster 528 with the database entry. This data may then be sent to the edge environment 102. When the charge session ends (e.g., the electric vehicle 114a is unplugged), that action will be added to the database entry and the database entry may be moved from a current sessions list to a completed sessions list. Thus, information associated with the app-less charging session can be obtained by an app.

As indicated above, the hardware platform 530 may represent hardware that may be utilized to execute the components described regarding FIG. 5. As such, the CPU 534 may be configured as any processing unit for receiving and executing computer-readable instructions. The storage component 536 may be configured as any hard drive or other local storage device. The memory component 538 may be configured as any type of RAM, ROM, registers, etc. or the like.

### Example Data Structures

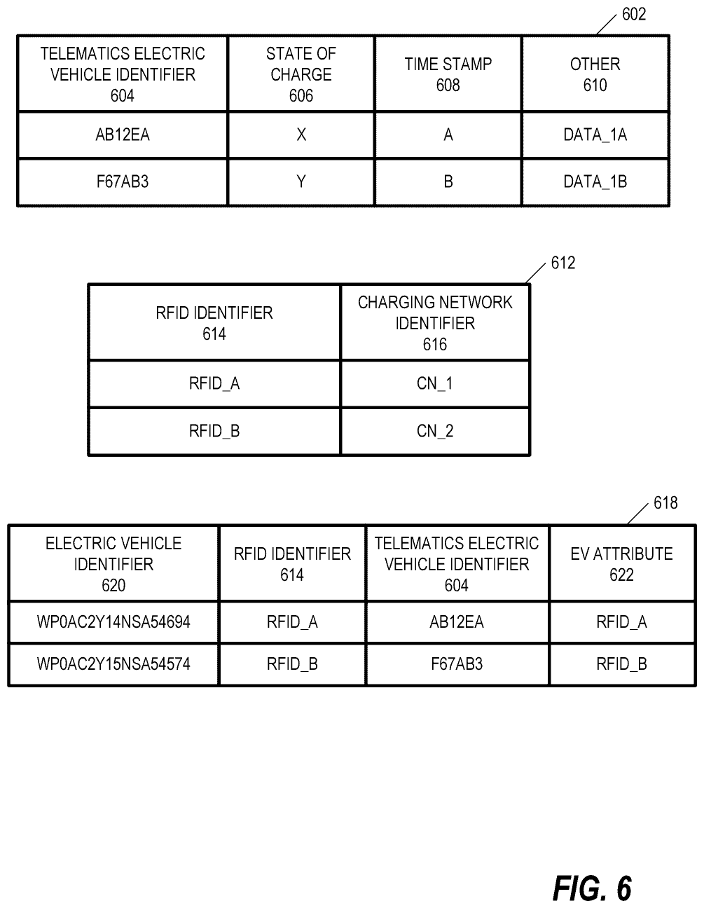

FIG. 6 depicts example data structures in accordance with embodiments of the present disclosure. A first data structure 602 generally refers to a data structure that includes telematics related information. As depicted in FIG. 6, the first data structure 602 includes a telematics electric vehicle identifier 604 which uniquely identifies an electric vehicle. The first data structure 602 can also include a state of charge 606 of a battery associated with the electric vehicle as well as a timestamp 608 associated with the data entry. In examples, where a time stamp is greater than a threshold value (older by more than a threshold amount of time such as thirty minutes), the app-less session service 540 may determine that the entry is stale and generate energy requests based on a state of charge that is equal to zero. The first data structure 602 can also include other telematics information 610 specific to the electric vehicle 114a (from FIGS. 1 and 5). Although depicted as including two entries, it should be understood that the first data structure 602 can include more or fewer than two entries and can include entries from more or fewer than two electric vehicles 114a. The first data structure 602 can be stored in the database 532 and/or accessed via a telematics system 546.

A second data structure 612 generally refers to a data structure that includes RFID and charge network related information. As depicted in FIG. 6, the second data structure 612 includes an RFID identifier 614 and a charging network identifier 616. The RFID identifier 614 may uniquely identify an RFID card and can be obtained from an RFID reader or other proximity-based communication reader, such as RFID reader 116 when the RFID reader 116 interrogates an RFID card, such as the RFID card 118. The charging network identifier 616 can uniquely identify a charging facility and/or charging network. Although depicted as including two entries, it should be understood that the second data structure 612 can include more or fewer entries than illustrated and can include entries from more or fewer than two RFID cards. The second data structure 612 can be stored in the database 532.

A third data structure 618 generally refers to a data structure that includes entry information associating an electric vehicle identifier 620 with one or more RFID identifiers 614, telematics electric vehicle identifier 604, and one or more electric vehicle attributes 622. In examples, the electric vehicle identifier 620 can uniquely identify an electric vehicle within a fleet management system or application. Accordingly, the RFID identifier 614 can be used by the app-less session service 540 to determine if an RFID card is authorized to charge an electric vehicle, and if so, identify the electric vehicle by referencing the electric vehicle identifier 620 and/or the telematics electric vehicle identifier 604. In examples, the electric vehicle attribute 622 can reference one or more attributes associated with an electric vehicle and may include, but is not limited to, a VIN, a battery charge capacity, a schedule or location of an electric vehicle schedule, etc. Although depicted as including two entries, it should be understood that the third data structure 618 can include more or fewer entries than illustrated. The third data structure 618 can be stored in the database 532.

### Process for Performing an App-Less Charging Session

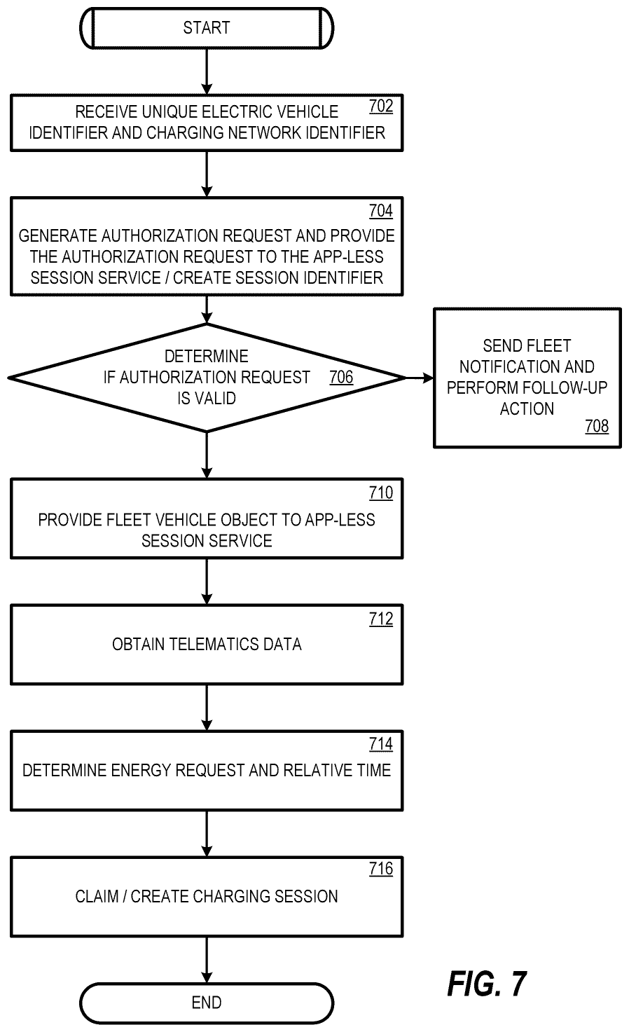

FIG. 7 depicts a flowchart for linking an electric vehicle 114a to a charging session to facilitate charge scheduling and charge optimization through a linkage mechanism distinct from a mobile app, according to embodiments provided herein. As illustrated in block 702, a unique electric vehicle identifier and charging network identifier can be received. For example, the unique electric vehicle identifier can be received from an RFID reader 116 upon the interrogation of an RFID card 118, where the unique vehicle identifier is or otherwise is associated with an identifier of the RFID card 118. In some examples, the unique electric vehicle identifier can be received from telematics geo-referencing data, a kiosk scan, and/or a reference from an ISO 15118 communication secured by a TLS connection between an electric vehicle and an EVSE. At block 704, an authorization request can be generated and provided to an app-less session service. In some examples, an app-less session identifier can be created and associated with the receipt of the electric unique vehicle identifier. In some examples, the app-less session service 540 creates the authorization request. At block 706, the unique electric vehicle identifier, such as the identifier associated with the RFID card 118, can be used to determine if the authorization request is valid. For example, a data structure, such as the third data structure 618 (of FIG. 6) can include queries using the unique electric vehicle identifier (e.g., RFID identifier 614). If the RFID identifier 614 is listed in the third data structure 618, then a status of future charging session as pulled from one or more electric vehicle attributes 622 can be utilized to determine if authorization request is valid. As another example, if the RFID identifier 614 is listed in the third data structure 618, then the authorization request can be considered to be valid. If, however, the RFID identifier 614 is not listed in the third data structure 618 for example, then a notification can be sent to a fleet point of contact or another operation can be performed at 708.

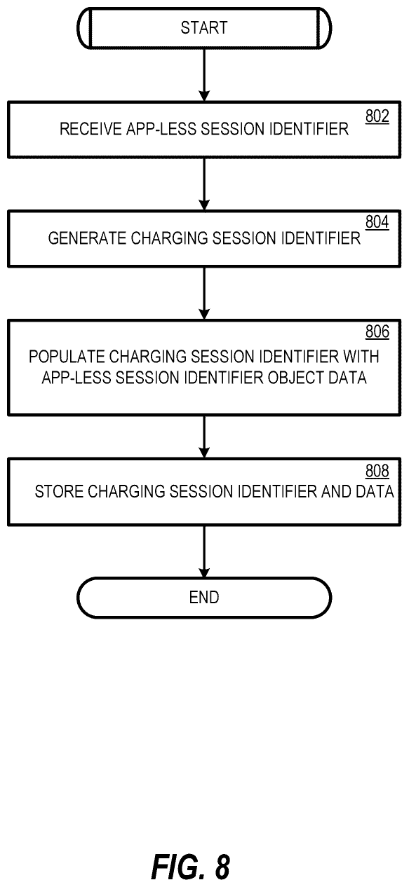

If the RFID identifier 614 is considered to be valid, then a fleet vehicle object can be provided back to the app-less session service 540 at block 710. In some embodiments, the fleet vehicle object can include one or more of a telematics electric vehicle identifier 604, electric vehicle identifier 620, or electric vehicle attribute 622, where the electric vehicle attribute 622 can refer to or otherwise provide a battery charge capacity and electric vehicle schedule. At block 712, telematics information can be obtained. For example, the telematics electric vehicle identifier 604 can be used to obtain real-time information about the electric vehicle such as but not limited to the state of charge of the battery. At block 714, an energy request and associated relative time can be determined. For example, the app-less session service 540 can generate an energy request based on the electric vehicle state of charge and electric vehicle schedule such that the electric vehicle can be charged in anticipation of an upcoming task. As depicted at block 716, the app-less session can be claimed and associated with a charging request as previously described and as described with respect to FIG. 8.

FIG. 8 depicts a flowchart for claiming an app-less charging session according to embodiments provided herein. As illustrated at block 802, an app-less session identifier can be received. In examples, the app-less session identifier can be created by the app-less session service upon receiving a unique electric vehicle identifier (e.g., identifier associated with an RFID card 118) and charging network identifier. For example, the app-less session may reference that a charging session was initiated or occurred based on the receipt of an identifier associated with an RFID card 118. In some embodiments, a database entry can be added with data including, but not limited to, the charge session, driver, identifier associated with the RFID, energy request, willingness to pay, electricity purchased, etc. When the charging session ends (e.g., the electric vehicle 114a is unplugged), that action will be added to the database entry and the database entry may be moved from a current sessions list to a completed sessions list. In some examples, and as illustrated at block 804, a charging session identifier can be created during the app-less charging event or subsequent to the app-less charging event. Thus, as illustrated at block 806, the charging session identifier can be updated with app-less session information (also referred to as app-less session identifier object data). Alternatively, or in addition, the charging session identifier can be associated with the app-less session identifier received at 802. At block 808, the charging session identifier, app-less charging session identifier, and data can be stored. For example, a database entry can include the charging session identifier, the app-less charging session identifier, driver, identifier associated with the RFID, energy request, willingness to pay, electricity purchased, etc. Thus, information associated with the app-less charging session can be obtained by an app.

### Example Processing System for Linking an Electric Vehicle to a Charging Session Using a Linkage Mechanism Distinct from a Mobile App

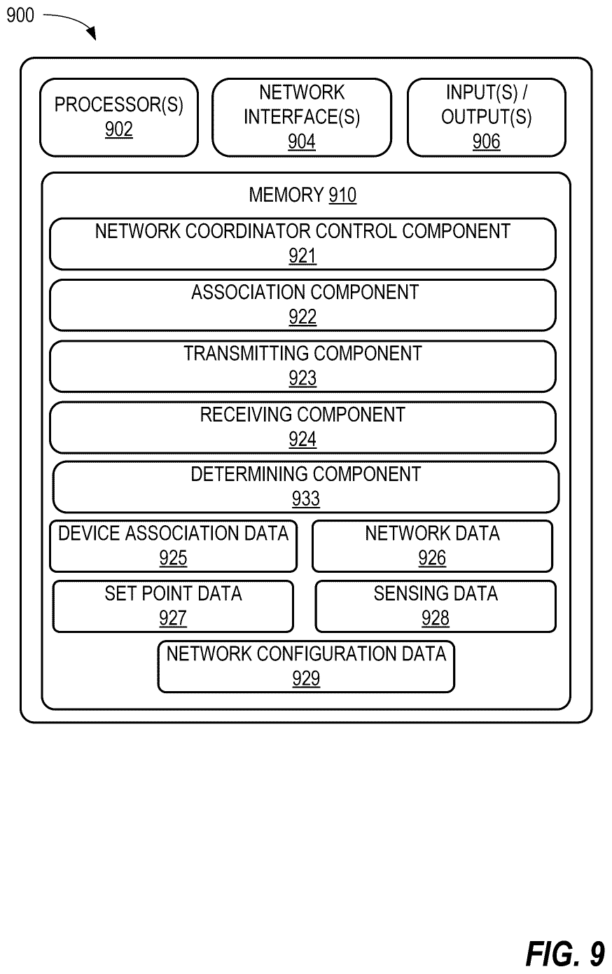

FIG. 9 depicts an example processing system 900 configured to perform the methods described herein.

Processing system 900 includes one or more processors 902. Generally, a processor 902 is configured to execute computer-executable instructions (e.g., software code) to perform various functions, as described herein.

Processing system 900 further includes one or more network interfaces 904, which generally provide data access to any sort of data network, including personal area networks (PANs), local area networks (LANs), wide area networks (WANs), the Internet, and the like.

Processing system 900 further includes input(s) and output(s) 906, which generally provide means for providing data to and from processing system 900, such as via connection to computing device peripherals, including user interface peripherals.

Processing system 900 further includes a memory 910 comprising various components. In this example, memory 910 includes a network coordinator control component 921, an association component 922, a transmitting component 923, a receiving component 924, a determining component 933, device association data 925, network data 926, set point data 927, sensing data 928, and network configuration data 929.

Processing system 900 may be implemented in various ways. For example, processing system 900 may be implemented as a computing device 402 within core device 302, described above with respect to FIGS. 3 and 4. Alternatively, or in addition, the processing system 900 may be implemented as an RFID reader 116 communicating with the charging station 112 and/or the edge gateway 202. Alternatively, or in addition, the processing system 900 may be implemented as a telematics system 546. Note that in various implementations, aspects may be omitted, added, or substituted from processing system 900.

Techniques discussed herein for linking an electric vehicle to a charging session provide a technical solution to the problem of efficiently managing charging for electric vehicle fleets. The use of RFID identifiers to initiate and track charging sessions enables scaling as fleets expand, as opposed to manual tracking which becomes infeasible at scale. Retrieving telematics data via the RFID identifier allows tailored charging requests optimized for individual electric vehicle batteries, overcoming limitations of one-size-fits-all charging. This improves battery health and operational efficiency. Further, attributing charging costs and data to accounts based on RFID identifiers facilitates precise tracking and cost allocation, overcoming inaccuracies of manual attribution.

Techniques discussed herein for app-less charging improve the technical field of electric vehicle fleet and charging infrastructure management. Relying solely on smartphone apps creates dependency issues if a user's phone is unavailable. The app-less techniques broaden access to charging services. Further, the app-less techniques link the RFID-initiated session to a mobile app session. This allows users to claim and view details of RFID-initiated sessions through the mobile app interface.

### Example Clauses

Implementation examples are described in the following numbered clauses:

Clause 1: A method for initiating a charging session for an electric vehicle, comprising: receiving a charging request initiated by a proximity-based communication from a wireless identification tag, the charging request comprising a wireless identifier associated with the electric vehicle and derived from the wireless identification tag; authorizing the charging request based on the wireless identifier; retrieving a unique telematics identifier corresponding to the wireless identifier; querying a telematics system with the unique telematics identifier to obtain vehicle-specific data, the vehicle-specific data comprising a state of charge attribute for a battery associated with the electric vehicle; determining a charge amount based on the state of charge attribute; and authorizing the determined charge amount for the charging session.

Clause 2: The method according to Clause 1, wherein authorizing the charging request based on the wireless identifier comprises: querying a database of wireless identifiers to determine if the wireless identifier is contained within the database, and authorizing the charging request based on an attribute associated with a result of the querying of the database of wireless identifiers.

Clause 3: The method according to Clause 2, wherein the charging request is received from an edge environment configured to perform localized data processing and to facilitate communication between the electric vehicle and a central computing resource for obtaining the vehicle-specific data from a telematics system.

Clause 4: The method according to any one of Clauses 1-3, further comprising: generating an app-less charging session identifier associated with the received charging request, wherein the app-less charging session identifier is generated before the charging request is authorized; and associating the app-less charging session identifier with a charging session identifier associated with an application accessible by a mobile device.

Clause 5: The method according to any one of Clauses 1-4, further comprising: receiving, at a proximity-based communication reader, the wireless identifier; providing, by the proximity-based communication reader, the wireless identifier to an edge environment; generating, by the edge environment, the charging request, wherein the charging request comprises the wireless identifier and a charging network identifier associated with an electric vehicle charger; and authorizing the electric vehicle charger to provide the determined charge amount to the electric vehicle.

Clause 6: The method according to any one of Clauses 1-5, further comprising: receiving a timestamp for the state of charge attribute associated with the electric vehicle; and setting the state of charge attribute associated with the electric vehicle to a specific value when the timestamp exceeds a threshold value.

Clause 7: The method according to any one of Clauses 1-6, wherein the determined charge amount is based on a schedule for the electric vehicle.

Clause 8: One or more apparatuses, comprising: one or more memories comprising executable instructions; and one or more processors configured to execute the executable instructions and cause the one or more apparatuses to perform a method in accordance with any one of Clauses 1-7.

Clause 9: One or more apparatuses, comprising means for performing a method in accordance with any one of Clauses 1-7.

Clause 10: One or more non-transitory computer-readable media comprising executable instructions that, when executed by one or more processors of one or more apparatuses, cause the one or more apparatuses to perform a method in accordance with any one of Clauses 1-7.

Clause 11: One or more computer program products embodied on one or more computer-readable storage media comprising code for performing a method in accordance with any one of Clauses 1-7.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) (logic) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for initiating a charging session for an electric vehicle, comprising:
receiving a charging request initiated by a proximity-based communication from a wireless identification tag, the charging request comprising a wireless identifier associated with the electric vehicle and derived from the wireless identification tag;
authorizing the charging request based on the wireless identifier;
retrieving a unique telematics identifier corresponding to the wireless identifier;
querying a telematics system with the unique telematics identifier to obtain vehicle-specific data, the vehicle-specific data comprising a state of charge attribute for a battery associated with the electric vehicle;
determining a charge amount based on the state of charge attribute; and
authorizing the determined charge amount for the charging session.

2. The method of claim 1, wherein authorizing the charging request based on the wireless identifier comprises:
querying a database of wireless identifiers to determine if the wireless identifier is contained within the database, and
authorizing the charging request based on an attribute associated with a result of the querying of the database of wireless identifiers.

3. The method of claim 2, wherein the charging request is received from an edge environment configured to perform localized data processing and to facilitate communication between the electric vehicle and a central computing resource for obtaining the vehicle-specific data from the telematics system.

4. The method of claim 1, further comprising:
generating an app-less charging session identifier associated with the received charging request, wherein the app-less charging session identifier is generated before the charging request is authorized; and
associating the app-less charging session identifier with a charging session identifier associated with an application accessible by a mobile device.

5. The method of claim 1, further comprising:
receiving, at a proximity-based communication reader, the wireless identifier;
providing, by the proximity-based communication reader, the wireless identifier to an edge environment;
generating, by the edge environment, the charging request, wherein the charging request comprises the wireless identifier and a charging network identifier associated with an electric vehicle charger; and
authorizing the electric vehicle charger to provide the determined charge amount to the electric vehicle.

6. The method of claim 1, further comprising:
receiving a timestamp for the state of charge attribute associated with the electric vehicle; and
setting the state of charge attribute associated with the electric vehicle to a specific value when the timestamp exceeds a threshold value.

7. The method of claim 1, wherein the determined charge amount is based on a schedule for the electric vehicle.

8. A system comprising:
a cloud environment that comprises a memory component and a processor, the cloud environment comprising an app-less session service, that when executed by the processor, causes the system to:
receive a charging request initiated by a proximity-based communication from a wireless identification tag, the charging request comprising a wireless identifier associated with an electric vehicle and derived from the wireless identification tag;
authorize the charging request based on the wireless identifier;
retrieve a unique telematics identifier corresponding to the wireless identifier;
query a telematics system with the unique telematics identifier to obtain vehicle-specific data, the vehicle-specific data comprising a state of charge attribute for a battery associated with the electric vehicle;
determine a charge amount based on the state of charge attribute; and
authorize the determined charge amount for a charging session.

9. The system of claim 8, wherein to authorize the charging request based on the wireless identifier, the app-less session service, when executed by the processor, causes the system to:
query a database of wireless identifiers to determine if the wireless identifier is contained within the database, and
authorize the charging request based on an attribute associated with a result of the query of the database of wireless identifiers.

10. The system of claim 9, wherein the charging request is received from an edge environment configured to perform localized data processing and to facilitate communication between the electric vehicle and a central computing resource for obtaining the vehicle-specific data from the telematics system.

11. The system of claim 8, wherein the app-less session service, when executed by the processor, further causes the system to generate an app-less charging session identifier associated with the received charging request before the charging request is authorized, wherein at least one service in the cloud environment associates the app-less charging session identifier with a charging session identifier associated with an application accessible by a mobile device.

12. The system of claim 8, further comprising a proximity-based communication reader configured to:
receive the wireless identifier; and
provide the wireless identifier to an edge environment.

13. The system of claim 12, wherein the edge environment is configured to generate the charging request, wherein the charging request comprises the wireless identifier and a charging network identifier associated with an electric vehicle charger.

14. The system of claim 13, wherein the cloud environment is configured to authorize the electric vehicle charger to provide the determined charge amount to the electric vehicle.

15. The system of claim 8, wherein the determined charge amount is based on a schedule for the electric vehicle.

16. A non-transitory computer-readable medium comprising computer-executable instructions that, when executed by a processor of a processing system, cause the processing system to:
receive a charging request initiated by a proximity-based communication from a wireless identification tag, the charging request comprising a wireless identifier associated with an electric vehicle and derived from the wireless identification tag;
authorize the charging request based on the wireless identifier;
retrieve a unique telematics identifier corresponding to the wireless identifier;
query a telematics system with the unique telematics identifier to obtain vehicle-specific data, the vehicle-specific data comprising a state of charge attribute for a battery associated with the electric vehicle;
determine a charge amount based on the state of charge attribute; and
authorize the determined charge amount for a charging session.

17. The non-transitory computer-readable medium of claim 16, wherein the computer-executable instructions further cause the processing system to query a database of wireless identifiers to determine if the wireless identifier is contained within the database, and to authorize the charging request based on an attribute associated with a result of the query of the database of wireless identifiers.

18. The non-transitory computer-readable medium of claim 16, wherein the computer-executable instructions further cause the processing system to generate an app-less charging session identifier associated with the received charging request, and to associate the app-less charging session identifier with a charging session identifier associated with an application accessible by a mobile device.

19. The non-transitory computer-readable medium of claim 16, wherein computer-executable the instructions further cause the processing system to generate the charging request comprising the wireless identifier and a charging network identifier associated with an electric vehicle charger.

20. The non-transitory computer-readable medium of claim 16, wherein the determined charge amount is based on a schedule for the electric vehicle.
